(19) United States
(12) Patent Application Publication
(10) Pub. No.: US 2025/0010873 A1
(43) Pub. Date: Jan. 9, 2025

(54) System and Method for Providing Passenger-Initiated Cruise Control Disable Input

(71) Applicant: Lana Mya Eitel, Lantana, FL (US)

(72) Inventor: Lana Mya Eitel, Lantana, FL (US)

(21) Appl. No.: 17/899,439

(22) Filed: Aug. 30, 2022

(51) Int. Cl. B60W 50/12; B60Q 1/50; B60W 20/00; B60W 30/14; B60W 50/10

(52) U.S. Cl. CPC B60W 50/12; B60Q 1/544; B60W 20/00; B60W 30/143; B60W 50/10; B60W 2520/10; B60W 2540/26

(57) ABSTRACT

A system and method providing a passenger-initiated cruise control disable input according to the present invention includes a cruise control subsystem within a vehicle, driver controls communicatively coupled to the cruise control subsystem, one or more passenger controls located within the vehicle within rear of passengers of the vehicle and being communicatively coupled to the cruise control subsystem, one or more sensors providing vehicle operating speed measurements are communicatively coupled to the cruise control sub system, and a vehicle propelling motor communicatively coupled to the cruise control subsystem and to the driver controls. The method causes the vehicle to activate a cruise control subsystem by a driver for controlling a vehicle propelling motor communicatively coupled to the cruise control subsystem and to driver controls, set a desired vehicle speed by the driver in the cruise control subsystem for use by the vehicle propelling motor, generate a disable signal by a passenger using passenger controls communicatively coupled to the cruise control subsystem for deactivating operation of the cruise control subsystem and for preventing the driver controls from reactivating the cruise control system from controlling the vehicle propelling motor until the passenger controls are returned to a default state, and cause the vehicle to a complete stop until the disable signal is deactivated.

### TECHNICAL FIELD

This application generally relates to a system and method providing a vehicle control, and more specifically, to a system and method providing a passenger-initiated cruise control disable input.

### BACKGROUND

Vehicles have increasingly included automated controls that operate various parts of the vehicle without needing input from a driver. For example, cruise control, automatic braking, and lane steering controls all permit the vehicle to travel down a highway without a driver providing input via the steering wheel, gas pedal, and brake pedals. These automated controls may be activated or disabled by a driver at any time. Passengers riding within the vehicle with the driver currently have no mechanism to disable these automated controls and bring the vehicle to a controlled stop if desired. Such an ability may be needed if the driver becomes incapacitated while driving and if the passenger needs to exit the vehicle without the approval of the driver.

Therefore, a need exists for a system and method providing a passenger-initiated cruise control disable input. The present invention attempts to address the limitations and deficiencies in prior solutions according to the principles and example embodiments disclosed herein.

### SUMMARY

In accordance with the present invention, the above and other problems are solved by providing a system and method for a passenger-initiated cruise control disable input according to the principles and example embodiments disclosed herein.

In one embodiment, the present invention is a system providing a passenger-initiated cruise control disable input. The system includes a cruise control subsystem within a vehicle, driver controls communicatively coupled to the cruise control subsystem, one or more passenger controls located within the vehicle within rear of passengers of the vehicle and being communicatively coupled to the cruise control subsystem, one or more sensors providing vehicle operating speed measurements are communicatively coupled to the cruise control sub system, and a vehicle propelling motor communicatively coupled to the cruise control subsystem and to the driver controls.

According to another aspect of the system, the passenger controls transmits a disable signal to the cruise control subsystem to deactivate operation of the cruise control subsystem.

According to another aspect of the system, the disable system further prevent the driver controls from reactivating the cruise control system from controlling the vehicle propelling motor until the passenger controls are returned to a default state.

According to another aspect of the system, the disable system further causes the vehicle to come to a complete stop.

According to another aspect of the system, the vehicle propelling motor comprises an internal combustion engine and one or more electric motors.

According to another aspect of the system, the passenger controls comprise a separate kill switch accessible to passengers seated in a front passenger seat and one or more rear passenger seats within the vehicle.

According to another aspect of the system, the system further comprises brakes communicatively coupled to the cruise control system for causing the vehicle to come to a complete stop.

According to another aspect of the system, the system further comprises four-way flashers coupled to the cruise control subsystem being activated when one of the passenger controls generates the disable signal.

In another embodiment, the present invention is a method providing a passenger-initiated cruise control disable input. The method causes the vehicle to activate a cruise control subsystem by a driver for controlling a vehicle propelling motor communicatively coupled to the cruise control subsystem and to driver controls, set a desired vehicle speed by the driver in the cruise control subsystem for use by the vehicle propelling motor, generate a disable signal by a passenger using passenger controls communicatively coupled to the cruise control subsystem for deactivating operation of the cruise control subsystem and for preventing the driver controls from reactivating the cruise control system from controlling the vehicle propelling motor until the passenger controls are returned to a default state, and cause the vehicle to a complete stop until the disable signal is deactivated.

According to another aspect of the method, the vehicle propelling motor comprises an internal combustion engine and one or more electric motors and the vehicle further comprises four-way flashers coupled to the cruise control subsystem being activated when one of the passenger controls generates the disable signal.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of a vehicle having a system providing a passenger-initiated cruise control disable input according to the present invention.

FIG. 2 illustrates a system providing a passenger-initiated cruise control disable input according to the present invention.

FIGS. 3a-b illustrate control logic components within a system and method providing a passenger-initiated cruise control disable input according to the present invention.

FIG. 4 illustrates control components within a system and method providing a passenger-initiated cruise control disable input according to the present invention.

FIG. 5 illustrates a flowchart corresponding to a method performed by software components of a system for providing a passenger-initiated cruise control disable input according to the present invention.

FIG. 6 illustrates a generalized schematic of a programmable processing system utilized as the various computing components described herein used to implement an embodiment of the present invention.

### DETAILED DESCRIPTION

This application generally relates to a system and method for providing a vehicle operational control, and more specifically, to a system and method providing a passenger-initiated cruise control disable input according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual,” and “user” refer to an entity, e.g., a human, using an article of manufacture providing a passenger-initiated cruise control disable input according to the present invention. The term user herein refers to one or more users.

The term “invention” or “present invention” refers to the invention being applied for via the patent application with the title “System and Method for Providing Passenger-Initiated Cruise Control Disable Input.” The invention may be used interchangeably with passenger disable.

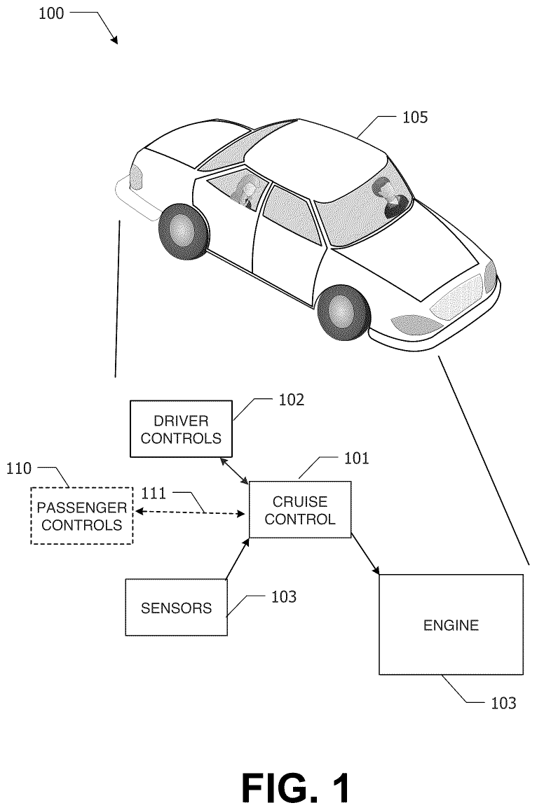

In general, the present disclosure relates to a system and method providing a passenger-initiated cruise control disable input according to the present invention. To better understand the present invention, FIG. 1 illustrates an example embodiment of a vehicle having a system providing a passenger-initiated cruise control disable input according to the present invention. A vehicle 105 operates using a vehicle propelling motor, for example an internal combustion engine 104 or an electric motor (not shown), to travel down a highway. A driver 115 controls the operation of the vehicle 105 using one or more driver controls 102 including a gas pedal, a brake pedal, and a steering wheel (not shown). If the driver 115 activates a cruise control subsystem 101, the cruise control 101 provides speed control input values 106 to the engine 104 in place of the driver 115 using the gas pedal. Similar arrangements may be configured for braking and lane maintenance and control functions typically provided directly by the driver 115 using the brake pedal and the steering wheel. Additionally, one or more sensors providing vehicle operating speed measurements are communicatively coupled to the cruise control subsystem.

A passenger 120 positioned within vehicle 105 in one of the other positions 105 typically does not have access to the driver controls 102 or typically does not have their own passenger controls 110. This arrangement results in the passenger 120 being unable to affect the speed, direction, and braking of the vehicle 105 should the driver 115 become incapacitated or refuse requests to exit from the passenger 120. The addition of passenger controls 110 may be accomplished by adding one or more passenger input controls located throughout the vehicle 105 within easy reach of a passenger 120 regardless of which seating position is occupied in the vehicle 105. These controls may be positioned both for front seat passengers as well as back seat passengers.

The passenger controls 110 in a preferred embodiment provide input signals to a cruise control 101 that automatically disables the cruise control 101 and causes the vehicle 105 to reduce speed. These passenger controls 110 may also provide corresponding signals to a braking system 402 to bring the vehicle 105 to a controlled stop if desired. The passenger controls 110 may comprise one or more switch devices that when closed provide a disable and/or stop signal to the various control devices, for example, driver controls 110 and the cruise control subsystem 101. This disable signal 111 may also prevent the driver 115 from reactivating the disabled control devices until the passenger controls 110 are returned to a default state. The disable signal 111 may also cause the vehicle 105 to come to a complete stop, a passenger 120 may be able to exit the vehicle safely before the driver 115 is able to operate the vehicle 105 once again.

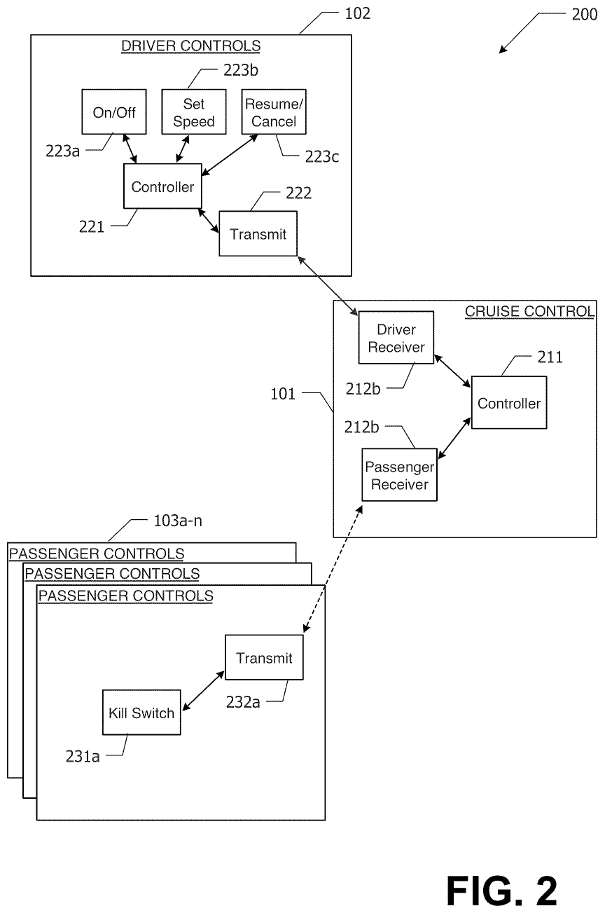

FIG. 2 illustrates a system providing a passenger-initiated cruise control disable input according to the present invention. Cruise control 101, driver controls 102, and passenger controls 110a-n are shown electrically coupled together in FIG. 2. The cruise control 101 comprises a driver input receiver 212a, one or more passenger receivers 212b, and a cruise control programmable controller 211 that cooperatively operate.

The driver input receiver 212a may receive one or more electrical signals from the driver controls 102 that represent various inputs the driver 115 may provide to the cruise control 101. The driver input receiver 212a may also receive an encoded digital input value that represents the input signals being transmitted from the driver controls 102 to the cruise control 101. The one or more passenger receivers 212b may operate in a similar arrangement to receive electrical signals or encoded digital values from the passenger controls 110. The passenger controls 110 typically comprise separate passenger controls instances 110a-n for each location within the vehicle 105 in which a passenger control 110 is located.

The cruise control programmable controller 211 comprises a programable computing device configured to execute firmware associated with the cruise control 101 to perform operating functions of the cruise control 101. These functions may be implemented as a method of operation as otherwise disclosed herein.

The driver controls 102 comprise a programmable driver input controller 221, one or more driver input devices 223a-c, and a driver controls transmitter 222. The driver controls 102 typically reside on a steering wheel and/or driver input levers (not shown) that provide additional input signals from the driver, for example, wiper blades and turn signals.

The programmable driver input controller 221 comprises a programable computing device configured to execute firmware associated with the driver controls 102 to perform operating functions of accepting driver inputs and providing these inputs to vehicle control devices, for example, the cruise control 101. These functions may be implemented as a method of operation as otherwise disclosed herein.

The one or more driver input devices 223a-c provide one or more switches that provide a driver 115 with the one or more input signals used to define a desired configuration of the vehicle control devices. For the cruise control 101, the one or more driver input devices 223a-c may comprise an on/off switch 223a, a set speed input switch 223b, and a resume/cancel input switch 223c. The on/off switch 223a may be a two-position switch that activates and deactivates the operation of the cruise control 101 based upon the state of its switch. Additional input devices may be included within the one or more driver input devices 223a-c to provide additional input commands to configure and operate the cruise control 101.

The set speed input switch 223b may be a three-position switch in which the switch rests in a default center position that permits the driver 115 to move a switch lever (not shown) upward or downward from the default center position to provide a first input command to the cruise control 101. For example, the set speed input switch 223b may generate an operation command to the cruise control 101 to define or redefine an operating setting. In preferred embodiments, the upper position of the set speed input switch 223b increases the desired operating speed of the cruise control 101 if the cruise control 101 is actively controlling the speed of the vehicle 105. Similarly, the lower position of the set speed input switch 223b decreases the desired operating speed of the cruise control 101 if the cruise control 101 is actively controlling the speed of the vehicle 105.

The resume/cancel input switch 223c may be a three-position switch in which the switch rests in a default center position that permits the driver 115 to move a switch lever (not shown) upward or downward from the default center position to provide a second input command to the cruise control 101. The upper position of the resume/cancel input switch 223c resumes control of the vehicle 105 at the desired operating speed of the cruise control 101 if the cruise control 101 is not actively controlling the speed of the vehicle 105. Similarly, the lower position of the resume/cancel input switch 223c pauses the control of the vehicle 105 by the cruise control 101 if the cruise control 101 is actively controlling the speed of the vehicle 105.

The driver controls transmitter 222 receives cruise control commands generated by the programmable driver input controller 221 based upon input commands provided by the one or more driver input devices 223a-c. The driver controls transmitter 222 transmits the cruise control commands to the driver input receiver 212a of the cruise control 101. As noted above, the cruise control commands may comprise one or more control signals transmitted to the driver input receiver 212a or may comprise encoded digital input values that represent the input signals being transmitted from the driver controls 102.

Each of the individual passenger controls 110a-n comprises one or more kill switches 232a-n, and one or more passenger control transmitters 232a-n (in which each of the kill switches 231i and transmitters 232i are located on corresponding passenger controls 110i). The kill switch 231a is a two position switch that causes the cruise control 101 to be disabled and may cause the vehicle 105 to be brought to a controlled stop when in an activated position. A passenger 120 placing one of the one or more kill switches 231a-n into its disable position commands the cruise control 101 to be disabled and may cause the vehicle 105 to be brought to a controlled stop when in an activated position.

The passenger control transmitter 232a transmits the passenger input command indicated by the kill switches 231a-n to the passenger receiver 212b within the cruise control 101. The passenger input command may be an electrical signal, or an encoded digital value as described above.

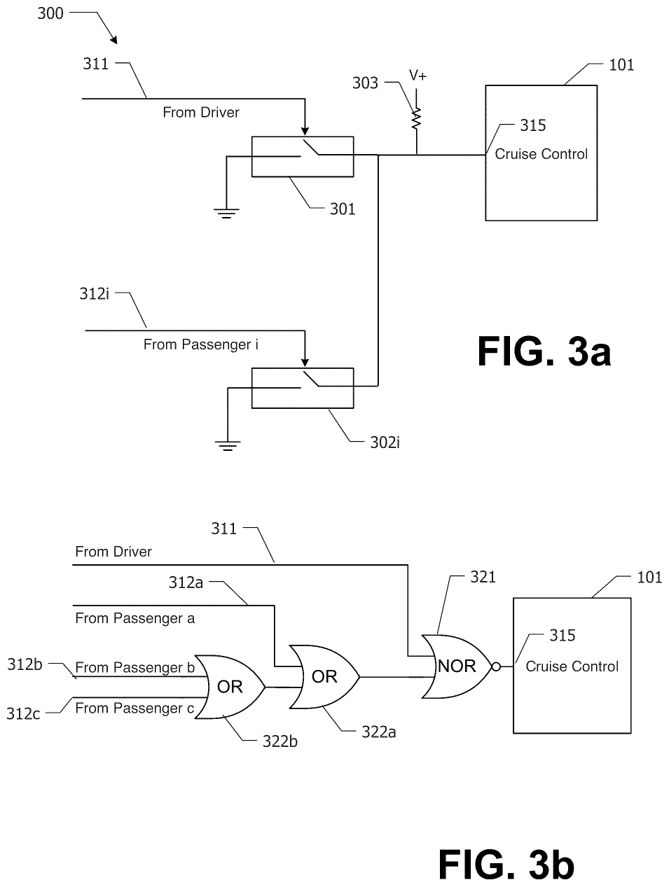

FIGS. 3a-b illustrate control logic components within a system and method providing a passenger-initiated cruise control disable input according to the present invention. FIG. 3a shows a circuit arrangement 300 for combining a driver input command 311 and a passenger input command 312a-n to be input into the cruise control 101. Each of these input commands 311, 312a-n are used as input control signals to an input relay 301, 302a-n. A first input to each input relay 301, 302a-n are electrically coupled together along with a pull-up resistor 303. The voltage generated by the pull-up resistor 303 corresponds to a combined input signal 315 to the cruise control 101. A second input to each input relay 301, 302a-n are electrically coupled to a ground plate of the vehicle 105, for example, the vehicle 105 body and frame. When one of these input commands 311, 312a-n is activated, the corresponding input relay 301, 301a-n closes causing the pull-up resistor 303 to be pulled to the ground plane of the vehicle 105. The cruise control 101 may detect this input signal that one of the occupants' controls (i.e. driver controls 102 and passenger controls 110) has activated a kill switch requesting that the cruise control 101 be disabled and the vehicle 105 be brought to a controlled stop.

FIG. 3b shows a logical circuit arrangement 330 that combines the input commands 311, 312a-n to generate a logical input signal to the signal input 315 of the cruise control 101. The logical circuit arrangement 330 comprises a plurality of logical OR gates 322a-n that combine all of the passenger input command signals 312a-n. The output of the combination of the OR gates receiving all of the passenger input command signals 312a-n is input to a NOR gate 321 along with a driver command signal 311 to generate the logical input signal to the signal input 315 of the cruise control 101. One of ordinary skill will recognize that this logical circuit arrangement 330 may be implemented using more than two-input OR gates in place of the multiple OR gates of FIG. 3b and other similar logical combinations of signals.

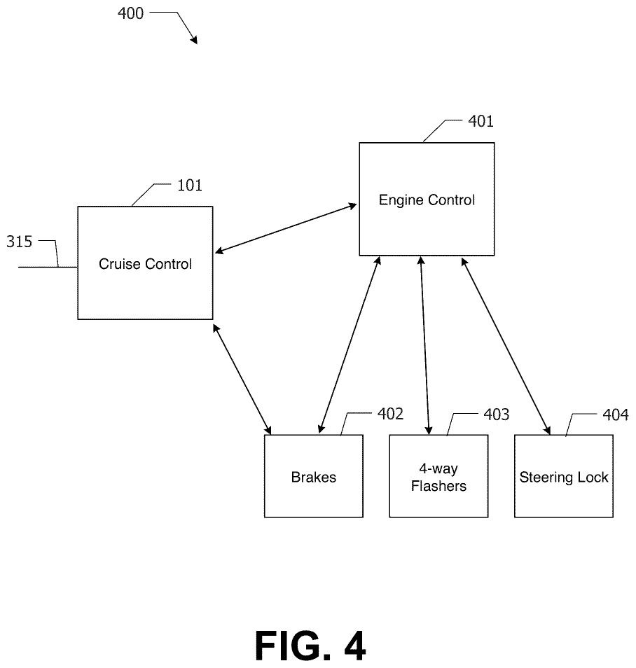

FIG. 4 illustrates control components within a system and method providing a passenger-initiated cruise control disable input according to the present invention. FIG. 4 shows a system 400 that utilizes the input command signal 315 received by the cruise control 101 to interact with other control devices 402-404 to cause the vehicle 105 to come to a controlled stop. The cruise control 101 may transmit a controlled stop signal 411 to an engine controller 401. The engine controller 401 may comprise one or more programmable controllers within a vehicle 105 to control the operation of the engine and other subsystems in the vehicle 105. For example, the engine control 401 may transmit emergency situation command signals to a vehicle braking subsystem 402, a turn signal subsystem 403, and a steering controller 404.

Many vehicles 105 are now equipped with automated braking systems that bring a vehicle 105 to a stop without driver input when a potential crash is detected. The turn signal subsystem 403 typically generates 4-way safety flashers to indicate an emergency situation. Vehicles 105 also may be equipped with lane change detection and accident avoidance subsystems that include a steering controller 404 to keep vehicles within a traffic lane without input from a driver 115. The emergency situation command signals from the engine controller 401 may be used in combination with each other when a passenger activates a kill switch 231a-n to bring the vehicle 105 to a controlled stop by applying the brakes and keeping the vehicle 105 within a lane using the steering controller 404. The 4-way flashers also may be activated to inform nearby drivers of the emergency situation resulting in a controlled stop.

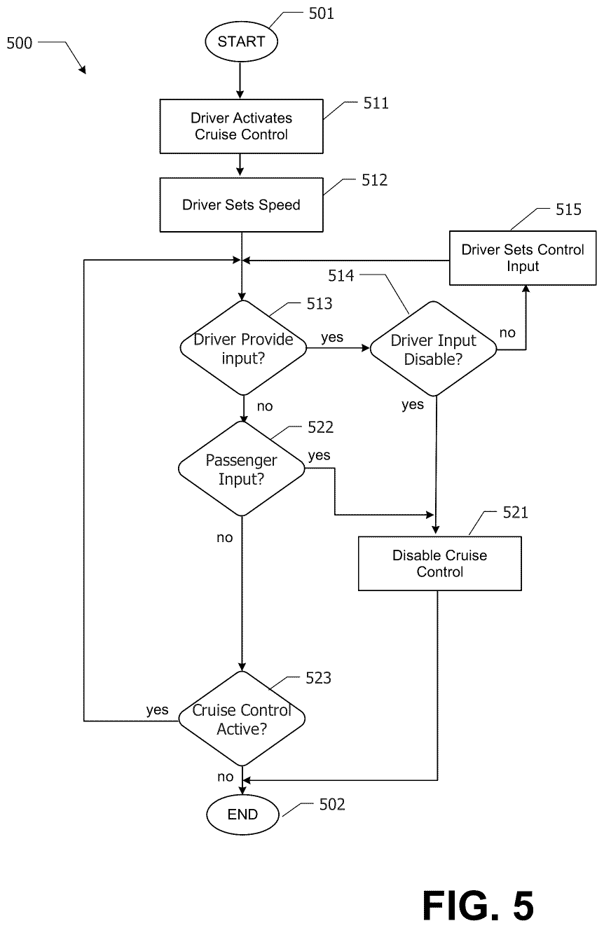

FIG. 5 illustrates a flowchart corresponding to a method performed by software components of a system for providing a passenger-initiated cruise control disable input according to the present invention. The process flow 500 begins 501 when a vehicle 105 activates the cruise control 101 in step 511. The driver 115 sets the desired operating speed of the cruise control 101 in step 512.

Test step 513 begins a main processing loop by determining whether the vehicle 105 has provided an input command from the driver controls 102, and if not, the process flow 500 continues to test step 522 to determine whether a passenger 120 has provided a disable command from the passenger controls 110. When test step 522 determines that a passenger 120 has not provided an input command, the process flow 500 proceeds to test step 523 to determine whether the process flow 500 is to continue, and if so, the process flow 500 returns to test step 513 to perform another pass through the main processing loop; otherwise the process flow 500 ends 502.

When test step 513 determines that a driver has provided an input command, test step 514 determines whether the driver input command requests the cruise control 101 be disabled, and if not, the driver input command is performed in step 515 before the process flow 500 returns to test step 513 to perform another pass through the main processing loop. When test step 514 determines that the driver is disabling the cruise control 101, the disable command is performed in step 521 and the process flow 500 ends.

Returning to test step 522, when test step 522 determines the passenger 120 has provided a disable command from a kill switch, the process flow 500 also disables the cruise control 101 in step 521 before the process flow 500 ends 502.

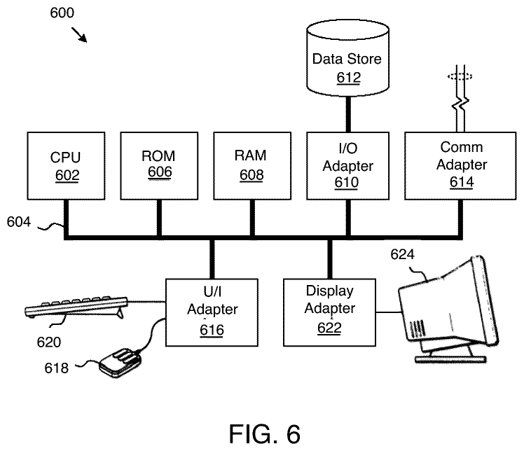

FIG. 6 illustrates a computer system 600 adapted according to certain embodiments of the server and/or the user interface device. The central processing unit (“CPU”) 602 is coupled to the system bus 604. The CPU 602 may be a general-purpose CPU or microprocessor, graphics processing unit (“GPU”), and/or microcontroller. The present embodiments are not restricted by the architecture of the CPU 602 so long as the CPU 602, whether directly or indirectly, supports the operations as described herein. The CPU 602 may execute the various logical instructions according to the present embodiments.

The computer system 600 also may include random access memory (RAM) 608, which may be synchronous RAM (SRAM), dynamic RAM (DRAM), synchronous dynamic RAM (SDRAM), or the like. The computer system 600 may utilize RAM 608 to store the various data structures used by a software application. The computer system 600 also may include read-only memory (ROM) 606 which may be PROM, EPROM, EEPROM, optical storage, or the like. The ROM 606 may store configuration information for booting the computer system 600. The RAM 608 and the ROM 606 hold user and system data, and both the RAM 508 and the ROM 606 may be randomly accessed.

The computer system 600 also may include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a solid-state storage device, a flash drive, a compact disc (CD) drive, a floppy disk drive, and a tape drive, to the computer system 600. According to one embodiment, the data storage 612 may be a separate server coupled to the computer system 600 through a network connection to the I/O adapter 610. The communications adapter 614 may be adapted to couple the computer system 600 to the network 110, which may be one or more of a LAN, WAN, and/or the Internet. The communications adapter 614 may also be adapted to couple the computer system 600 to other networks such as a global positioning system (GPS) or a Bluetooth network. The user interface adapter 616 couples user input devices, such as a keyboard 620, a pointing device 618, and/or a touch screen (not shown) to the computer system 600. The keyboard 620 may be an on-screen keyboard displayed on a touch panel. Additional devices (not shown) such as a camera, microphone, video camera, accelerometer, compass, and or gyroscope may be coupled to the user interface adapter 616. The display adapter 622 may be driven by the CPU 602 to control the display on the display device 624. Any of the devices 602-622 may be physical and/or logical.

The applications of the present disclosure are not limited to the architecture of the computer system 600. Rather the computer system 600 is provided as an example of one type of computing device that may be adapted to perform the functions of a computing device and/or the user interface device 610. For example, any suitable processor-based device may be utilized including, without limitation, personal data assistants (PDAs), tablet computers, smartphones, computer game consoles, and multi-processor servers. Moreover, the systems and methods of the present disclosure may be implemented on application-specific integrated circuits (ASIC), very large-scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 600 may be virtualized for access by multiple users and/or applications.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. A system providing a passenger-initiated cruise control disable input, the system comprises:
a cruise control subsystem within a vehicle;
driver controls communicatively coupled to the cruise control subsystem;
one or more passenger controls located within the vehicle within rear of passengers of the vehicle and being communicatively coupled to the cruise control subsystem;
one or more sensors providing vehicle operating speed measurements are communicatively coupled to the cruise control sub system; and
a vehicle propelling motor communicatively coupled to the cruise control subsystem and to the driver controls.

2. The system according to claim 1, wherein the passenger controls transmits a disable signal to the cruise control subsystem to deactivate operation of the cruise control subsystem.

3. The system according to claim 2, wherein the disable system further prevent the driver controls from reactivating the cruise control system from controlling the vehicle propelling motor until the passenger controls are returned to a default state.

4. The system according to claim 2, wherein the disable system further causes the vehicle to come to a complete stop.

5. The system according to claim 1, wherein the vehicle propelling motor comprises an internal combustion engine and one or more electric motors.

6. The system according to claim 1, wherein the passenger controls comprise a separate kill switch accessible to passengers seated in a front passenger seat and one or more rear passenger seats within the vehicle.

7. The system according to claim 4, wherein the system further comprises brakes communicatively coupled to the cruise control system for causing the vehicle to come to a complete stop.

8. The system according to claim 4, wherein the system further comprises four-way flashers coupled to the cruise control subsystem being activated when one of the passenger controls generates the disable signal.

9. A method providing a passenger-initiated cruise control disable input, the method comprises:
activating a cruise control subsystem by a driver for controlling a vehicle propelling motor communicatively coupled to the cruise control subsystem and to driver controls;
setting a desired vehicle speed by the driver in the cruise control subsystem for use by the vehicle propelling motor;
generating a disable signal by a passenger using passenger controls communicatively coupled to the cruise control subsystem for deactivating operation of the cruise control subsystem and for preventing the driver controls from reactivating the cruise control system from controlling the vehicle propelling motor until the passenger controls are returned to a default state; and
causing the vehicle to a complete stop until the disable signal is deactivated.

10. The method according to claim 9, wherein the vehicle propelling motor comprises an internal combustion engine and one or more electric motors; and
the vehicle further comprises four-way flashers coupled to the cruise control subsystem being activated when one of the passenger controls generates the disable signal.
